(19) United States
(12) Patent Application Publication
(10) Pub. No.: US 2022/0065760 A1
(43) Pub. Date: Mar. 3, 2022

(54) GAS PURIFICATION DEVICE, AND APPARATUS AND METHOD FOR MEASURING NOBLE GAS ISOTOPES

(71) Applicant: Northwest Institute of Eco-Environment and Resources, CAS, Lanzhou (CN)

(72) Inventors: Chunhui CAO, Lanzhou (CN); Liwu LI, Lanzhou (CN); Huanhuan ZHAO, Lanzhou (CN); Zhongping LI, Lanzhou (CN); Li DU, Lanzhou (CN)

(21) Appl. No.: 17/524,181

(22) Filed: Nov. 11, 2021

(30) Foreign Application Priority Data
Aug. 20, 2021 (CN) 202110961908.9

(51) Int. Cl. G01N 1/40; B01D 53/26; B01D 53/81; B01D 53/46; B01D 53/04; B01D 53/75; H01J 49/04

(52) U.S. Cl. CPC G01N 1/4044; B01D 53/265; B01D 53/81; B01D 53/46; B01D 53/0407; B01D 2257/80; H01J 49/0422; B01D 2253/1122; B01D 2257/108; B01D 2253/102; B01D 2257/11; B01D 53/75

(57) ABSTRACT

Disclosed are a gas purification device, and an apparatus and a method for measuring isotopes of noble gases. The gas purification device includes a housing and a purification mechanism. The housing is provided with a reaction chamber. The reaction chamber is in a vacuum state and is configured to hold a gas sample. The purification mechanism is arranged on the housing and is provided with a cavity. The cavity in the purification mechanism is communicated with the reaction chamber. The purification mechanism is configured to purify the gas sample in the reaction chamber to obtain a purified gas.

### CROSS-REFERENCE TO RELATED APPLICATIONS

This application claims the benefit of priority from Chinese patent application No. 202110961908.9, filed on Aug. 20, 2021. The content of the aforementioned application, including any intervening amendments thereto, is incorporated herein by reference in its entirety.

### TECHNICAL FIELD

The present application relates to analysis of noble gas isotopes, and more particularly to a gas purification device, and an apparatus and a method for measuring noble gas isotopes.

### BACKGROUND

In the prior art, the analysis of noble gases is generally performed using a linear purification system with flow-type operation, in which individual purification components are independently arranged, and the communication of the gas sample in the purification components is controlled through valves arranged at the front end and the rear end of each purification component. After the previous stage of purification is completed, a part of the gas sample is allowed to flow into the next purification component for purification, and the rest gas sample is pumped away by a vacuum pump, which indicates that each purification operation will cause a large gas loss. Therefore, there is an urgent need to overcome the high loss rate of the gas sample in the purification process using the linear purification system.

### SUMMARY

Based on this, it is necessary to provide a gas purification device, and an apparatus and a method for measuring noble gas isotopes to solve the technical problem of high loss rate of the gas sample in the linear purification system in the prior art.

Technical solutions of the present disclosure are described as follows.

In a first aspect, this application provides a gas purification device, comprising:

a housing; and

a purification mechanism;

wherein the housing is provided with a reaction chamber; the reaction chamber is in a vacuum state and is configured to accommodate a gas sample; the purification mechanism is arranged on the housing and is provided with a cavity; the cavity is communicated with the reaction chamber; and the purification mechanism is configured to purify the gas sample in the reaction chamber to obtain a purified gas.

In some embodiments, the purification mechanism comprises a water vapor removal assembly; the water vapor removal assembly is provided with a first accommodating cavity; the first accommodating cavity is communicated with the reaction chamber; and the water vapor removal assembly is configured to remove water vapor in the gas sample in the reaction chamber.

In some embodiments, the water vapor removal assembly comprises a cold finger and a cooling agent; the first accommodating cavity is provided on the cold finger; and the cold finger is configured to be soaked in the cooling agent and to cool the water vapor in the reaction chamber to condense into ice.

In some embodiments, the purification mechanism further comprises a reactive gas removal assembly; the reactive gas removal assembly is arranged on the housing; the reactive gas removal assembly is provided with a second accommodating cavity; the second accommodating cavity is in communication with the reaction chamber; and the reactive gas removal assembly is configured to remove reactive gases in the reaction chamber.

In an embodiment, the reactive gas removal assembly is a furnace containing sponge titanium.

In some embodiments, the purification mechanism further comprises a hydrogen gas removal assembly; the hydrogen gas removal assembly is arranged on the housing and is provided with a third accommodating cavity; the third accommodating cavity is in communication with the reaction chamber; and the hydrogen gas removal assembly is configured to remove hydrogen gas in the reaction chamber.

In an embodiment, the hydrogen gas removal assembly is a zirconium-aluminum getter pump.

In some embodiments, the purification mechanism further comprises an activated carbon trap; the activated carbon trap is arranged on the housing and is provided with a fourth accommodating cavity; the fourth accommodating cavity is in communication with the reaction chamber; and the activated carbon trap is configured to separate noble gases in the reaction chamber.

In a second aspect, this disclosure provides an apparatus for measuring noble gas isotopes, comprising:

the gas purification device; and

a noble gas isotope mass spectrometer;

wherein the noble gas isotope mass spectrometer is arranged on the gas purification device, and is configured to analyze the noble gases in the gas purification device.

In a third aspect, this disclosure provides a method for measuring noble gas isotopes, comprising:

feeding a gas sample into the reaction chamber of the housing; turning on the water vapor removal assembly to remove water vapor in the gas sample;

turning off the water vapor removal assembly, and turning on the reactive gas removal assembly to remove reactive gases in the gas sample treated by the water vapor removal assembly;

turning off the reactive gas removal assembly, and turning on the hydrogen gas removal assembly to remove hydrogen in the gas sample treated by the reactive gas removal assembly;

turning off the hydrogen gas removal assembly, and separating noble gases in the gas sample treated by the hydrogen gas removal assembly; and

turning on the noble gas isotope mass spectrometer to measure isotopes of individual noble gases.

Compared to the prior art, the present disclosure has the following beneficial effects.

The gas purification device provided herein includes a housing and a purification mechanism, where the housing is provided with a reaction chamber; the reaction chamber is in a vacuum state and can hold a gas sample; the purification mechanism is arranged on the housing and is provided with a cavity; and the cavity is communicated with the reaction chamber. Compared with the prior art, the purification mechanism of the present disclosure can directly purify the gas sample in the reaction chamber, and the whole purification process of the gas sample is carried out in the reaction chamber, so that there is no need to repeatedly divide the gas sample during purification, and also no need to allow the gas sample to flow from one purification component into another purification component, effectively avoiding the loss of the gas sample.

### BRIEF DESCRIPTION OF THE DRAWINGS

To render the technical solutions of the embodiments of the present disclosure or the prior art clearer, the drawings required in the description of the present disclosure or the prior art will be briefly described below. Obviously, presented in the following drawings are merely some embodiments of the disclosure, and for those of ordinary skill in the art, other drawings can be obtained based on the drawings disclosed herein without paying any creative effort.

FIG. 1 schematically shows a structure of a gas purification device and an apparatus for measuring noble gas isotopes according to an embodiment of the disclosure; and

FIG. 2 is a flow chart of a method for measuring noble gas isotopes according to an embodiment of the disclosure.

In the drawings: 100, housing; 110, reaction chamber; 200, purification mechanism; 210, water vapor removal assembly; 211, first valve; 220, reactive gas removal assembly; 221, second valve; 230, hydrogen gas removal assembly; 231, third valve; 240, activated carbon trap; 241, fourth valve; 300, vacuum gauge; 400, vacuum pump set; 410, fifth valve; and 500, noble gas isotope mass spectrometer.

The present disclosure will be further described with reference to the accompanying drawings and embodiments to make the object, function characteristics and advantages of the disclosure clearer.

### DETAILED DESCRIPTION OF EMBODIMENTS

The technical solutions in the embodiments of the present disclosure will be described clearly and completely below with reference to the accompanying drawings. It is apparent that provided below are merely some embodiments of the disclosure, which are not intended to limit the disclosure. It should be understood that other embodiments made by those skilled in the art based on the embodiments disclosed herein without paying any creative efforts should fall within the scope of the disclosure.

It should be noted that all directional indications used herein (such as upper, lower, left, right, front, and back) are only used to explain the relative positional relationship and motion situation between the components in a certain specific posture (as shown in the drawings), and if the specific posture changes, the directional indication also changes accordingly.

In addition, as used herein, the terms “first” and “second” are merely descriptive and should not be understood to indicate or imply relative importance or the number of the technical features referred to. Thus, a feature defined by “first” and “second” may explicitly or implicitly include at least one of the features. In addition, as used herein, the “and/or” includes three solutions. For example, the “A and/or B” includes A, B, and a combination thereof. Moreover, the technical solutions of the embodiments can be combined on the premise that the combined technical solutions can be implemented by those skilled in the art. If the combination of the technical solutions is contradictory or cannot be implemented, it should be considered that such a combination of the technical solutions does not exist, and does not fall within the protection scope of the present disclosure.

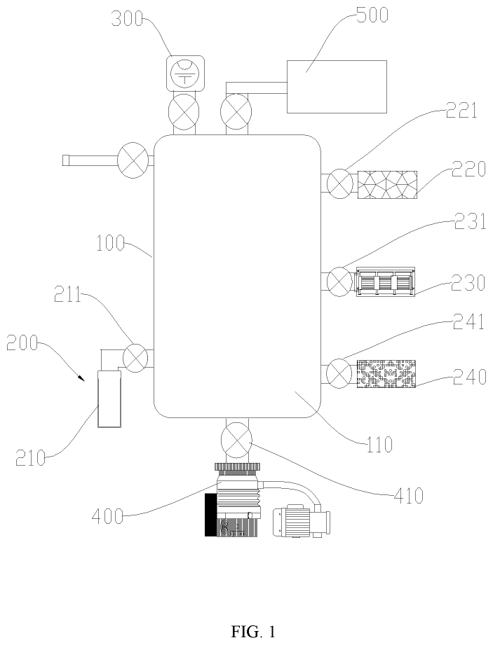

Referring to an embodiment shown in FIG. 1, a gas purification device includes a housing 100 and a purification mechanism 200. The housing 100 includes a reaction chamber 110. The reaction chamber 110 is in a vacuum state and can hold a gas sample. The purification mechanism 200 is arranged on the housing 100 and is provided with a cavity. The cavity in the purification mechanism 200 is communicated with the reaction chamber 110. The purification mechanism 200 is configured to purify the gas sample in the reaction chamber 110 to obtain a purified gas. Compared with the prior art, the purification mechanism 200 can directly purify the gas sample in the reaction chamber 110. The whole purification process of the gas sample is carried out in the reaction chamber 110, so that there is no need to repeatedly divide the gas sample during purification, and also no need to allow the gas sample to flow from one purification component into another purification component, effectively avoiding the loss of the gas sample.

In some embodiments, the housing 100 can be but is not limited to be made of a stainless steel material. In an embodiment, the housing 100 is made of a 304 stainless steel material. The stainless steel material has high enough strength, high-temperature resistance and chemical stability. An inner side wall of the housing 100 is polished to render the inner side wall of the housing 100 smoother, which can prevent the gas sample from being accommodated in the rough inner surface, ensuring the purification effect of the gas sample. The housing 100 and the purification mechanism 200 can withstand the high temperature baking at 250° C. for degassing. A vacuum degree can meet an ultra-vacuum requirement (lower than 10⁻⁸ Pa), and the gas sample can be stored in the reaction chamber 110 for at least 8 h without leakage.

In an embodiment, the housing 100 is connected to the purification mechanism 200 via a vacuum flange.

In some embodiments, the purification mechanism 200 includes a water vapor removal assembly 210. The water vapor removal assembly 210 is provided with a first accommodating cavity, and the first accommodating cavity is communicated with the reaction chamber 110. The water vapor removal assembly 210 is configured to remove water vapor in the gas sample in the reaction chamber 110 to purify the gas sample. In an embodiment, the water vapor removal assembly 210 is arranged at a bottom of the housing 100 to facilitate the discharge of the condensed water to the outside. The water vapor removal assembly 210 is connected to the housing 100 via a vacuum flange. The gas purification device further includes a first valve 211. The first valve 211 is arranged between the first accommodating cavity and the reaction chamber 110, and is configured to control the communication or isolation between the first accommodating cavity and the reaction chamber 110. After the first valve 211 is opened, the water vapor removal assembly 210 starts to purify the gas sample in the reaction chamber 110, and when the first valve 211 is closed, the water vapor removal assembly 210 stops purifying the gas sample in the reaction chamber 110.

In an embodiment, the water vapor removal assembly 210 includes a cold finger and a cooling agent. The cold finger is provided with the first accommodating cavity. The cold finger is soaked in the cooling agent and is used to cool and condense the water vapor in the reaction chamber into ice. The cooling agent can be but is not limited to liquid nitrogen. The cold finger is configured to remove impurity gas (such as water vapor) in the gas sample to purify the gas sample. Under the vacuum condition of the reaction chamber 110, the temperature of the cold finger can be reduced to −196° C. with liquid nitrogen such that the water vapor can be condensed into ice. Then the ice is collected in the first accommodating cavity of the cold finger such that the water vapor in the gas sample is removed.

In an embodiment, the purification mechanism 200 further includes a reactive gas removal assembly 220. The reactive gas removal assembly 220 is arranged on the housing 100. The reactive gas removal assembly 220 is provided with a second accommodating cavity, and the second accommodating cavity is in communication with the reaction chamber 110. The reactive gas removal assembly 220 is configured to remove reactive gases in the reaction chamber 110. In an embodiment, the reactive gas removal assembly 220 is a reduction/distillation furnace for production of sponge titanium. The reactive gas removal assembly 220 is connected to the housing 100 via a vacuum flange. The gas purification device further includes a second valve 221. The second valve 221 is arranged between the second accommodating cavity and the reaction chamber 110 and is configured to control the communication or isolation between the second accommodating cavity and the reaction chamber 110.

During operation, when the second valve 221 is opened, the gas sample without water vapor in the reaction chamber 110 reacts with the sponge titanium at a high temperature such that the reactive gas in the gas sample reacts with the active metal titanium to generate a non-gas substance to attach to the sponge titanium, thereby removing the reactive gas in the gas sample. When the second valve 221 is closed, the reactive gas in the reaction chamber 110 stops reacting with the sponge titanium. The metal titanium is very active and can react with gases other than noble gases at a high temperature. The sponge titanium has a large number of gaps and a large reaction surface area, and can contact with the gas sample fully, facilitating accelerating the reaction of the metal titanium and the reactive gas and improving the efficiency of removing the reactive gas.

In some embodiments, the purification mechanism 200 further includes a hydrogen gas removal assembly 230. The hydrogen gas removal assembly 230 is arranged on the housing 100 and is provided with a third accommodating cavity. The third accommodating cavity is in communication with the reaction chamber 110 and the hydrogen gas removal assembly is configured to remove hydrogen gas in the reaction chamber 110. The hydrogen gas removal assembly 230 is connected to the housing 100 via a vacuum flange. The gas purification device further includes a third valve 231. The third valve 231 is arranged between the third accommodating cavity and the reaction chamber 110 and is configured to control the communication or isolation between the third accommodating cavity and the reaction chamber 110. When the third valve 231 is opened, the hydrogen gas removal assembly 230 can purify the gas sample in the reaction chamber 110, and when the third valve 231 is closed, the hydrogen gas removal assembly 230 stops purifying the gas sample in the reaction chamber 110.

In an embodiment, the hydrogen gas removal assembly 230 is a zirconium-aluminum getter pump. The zirconium-aluminum getter pump is also referred to as a zirconium-aluminum suction pump, which can adsorb the reactive gas at a high temperature by using a zirconium-aluminum alloy getter material (84% zirconium and 16% aluminum). The zirconium-aluminum getter pump has a particularly high gas extraction capacity for hydrogen, but cannot extract inert gases.

The content of helium extracted from a natural geological sample is low, especially the concentration of helium isotope. The extracted helium gas can not be increased by increasing the amount of the sample in a laboratory, so the extracted helium can only be utilized to the maximum extent to enter a noble gas mass spectrometer for analysis. The gas purification device provided herein can be used for helium purification. As the influence of hydrogen gas on helium is large, it is necessary to ensure that there is no hydrogen gas in the reaction chamber 110.

In an embodiment, the purification mechanism 200 further includes an activated carbon trap 240. The activated carbon trap 240 is arranged on the housing 100 and is provided with a fourth accommodating cavity. The fourth accommodating cavity is in communication with the reaction chamber 110. The activated carbon trap 240 is configured to separate noble gases in the reaction chamber 110. The activated carbon trap 240 is connected to the housing 100 via a vacuum flange. The gas purification device further includes a fourth valve 241. The fourth valve 241 is arranged between the fourth accommodating cavity and the reaction chamber 110 and is configured to control the communication or isolation between the fourth accommodating cavity and the reaction chamber 110. When the fourth valve 241 is opened, the activated carbon trap 240 separates the noble gas in the reaction chamber 110. When the fourth valve 241 is closed, the activated carbon trap 240 cannot interact with the noble gas in the reaction chamber 110.

In some embodiments, the gas purification device further includes a vacuum gauge 300. The vacuum gauge 300 is connected to the housing 100 via a vacuum flange. The vacuum gauge 300 is configured to detect the vacuum degree in the reaction chamber 110 in real time.

The gas purification device further includes a vacuum pump set 400. The vacuum pump set 400 is connected to the housing 100 via a vacuum flange and is configured to maintain a vacuum state in the reaction chamber 110. The gas purification device further includes a fifth valve 410. The housing 100 is connected to the vacuum pump set 400 via the fifth valve 410. When the fifth valve 410 is opened, the group of vacuum pumps 400 can extract air in the reaction chamber 110 to maintain the vacuum state in the reaction chamber 110. When the fifth valve 410 is closed, the vacuum pump set stops acting on the reaction chamber 110.

An apparatus for measuring noble gas isotopes provided in an embodiment includes the gas purification device and a noble gas isotope mass spectrometer 500. The noble gas isotope mass spectrometer 500 is arranged on the gas purification device and is configured to measuring noble gases in the gas purification device. Specifically, the separated components (He, Ne, Ar, Kr and Xe) are respectively fed into the isotope mass spectrometer for isotope measurement to obtain the relative content and the isotope data.

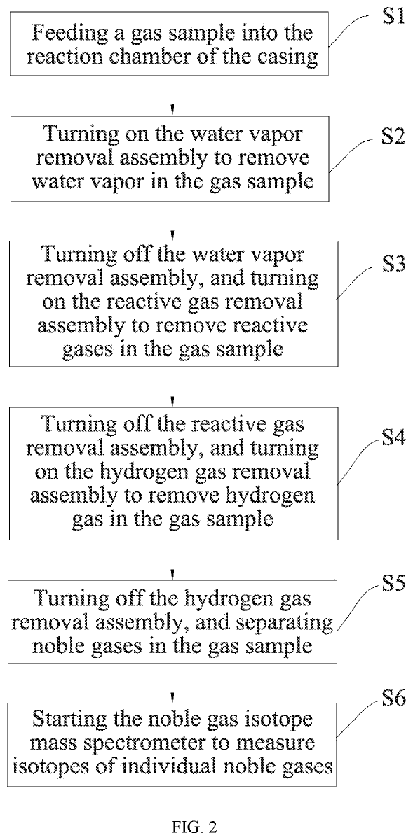

As shown in FIG. 2, an embodiment of the disclosure provides a method for measuring noble gas isotopes, which is described below.

(S1) A gas sample is fed into the reaction chamber 110 of the housing 100.

(S2) A water vapor removal assembly 210 is turned on to remove water vapor in the gas sample.

(S3) The water vapor removal assembly 210 is turned off, and a reactive gas removal assembly 220 is turned on to remove reactive gases in the gas sample treated by the water vapor removal assembly 210.

(S4) The reactive gas removal assembly 220 is turned off, and a hydrogen gas removal assembly 230 is turned on to remove hydrogen in the gas sample treated by the reactive gas removal assembly 220.

(S5) The hydrogen gas removal assembly 230 is turned off, and noble gases in the gas sample treated by the hydrogen gas removal assembly 220 are separated.

(S6) A noble gas isotope mass spectrometer is turned on to measure isotopes of individual noble gases.

Described above are only preferred embodiments of the present disclosure, which are not intended to limit the scope of the present disclosure. It should be understood that any modifications, replacements and changes made by those skilled in the art without departing from the spirit and scope of the disclosure shall fall within the scope of the disclosure defined by the appended claims.

What is claimed is:

1. A gas purification device, comprising:
a housing; and
a purification mechanism;
wherein the housing is provided with a reaction chamber; the reaction chamber is in a vacuum state and is configured to accommodate a gas sample; the purification mechanism is arranged on the housing and is provided with a cavity; the cavity is communicated with the reaction chamber; and the purification mechanism is configured to purify the gas sample in the reaction chamber to obtain a purified gas.

2. The gas purification device of claim 1, wherein the purification mechanism comprises a water vapor removal assembly; the water vapor removal assembly is provided with a first accommodating cavity; the first accommodating cavity is communicated with the reaction chamber; and the water vapor removal assembly is configured to remove water vapor in the gas sample in the reaction chamber.

3. The gas purification device of claim 2, wherein the water vapor removal assembly comprises a cold finger and a cooling agent; the first accommodating cavity is provided on the cold finger; and the cold finger is configured to be soaked in the cooling agent and to cool the water vapor in the reaction chamber to condense into ice.

4. The gas purification device of claim 1, wherein the purification mechanism further comprises a reactive gas removal assembly; the reactive gas removal assembly is arranged on the housing; the reactive gas removal assembly is provided with a second accommodating cavity; the second accommodating cavity is in communication with the reaction chamber; and the reactive gas removal assembly is configured to remove reactive gases in the reaction chamber.

5. The gas purification device of claim 4, wherein the reactive gas removal assembly is a reduction/distillation furnace for production of sponge titanium.

6. The gas purification device of claim 1, wherein the purification mechanism further comprises a hydrogen gas removal assembly; the hydrogen gas removal assembly is arranged on the housing and is provided with a third accommodating cavity; the third accommodating cavity is in communication with the reaction chamber; and the hydrogen gas removal assembly is configured to remove hydrogen gas in the reaction chamber.

7. The gas purification device of claim 6, wherein the hydrogen gas removal assembly is a zirconium-aluminum getter pump.

8. The gas purification device of claim 1, wherein the purification mechanism further comprises an activated carbon trap; the activated carbon trap is arranged on the housing and is provided with a fourth accommodating cavity; the fourth accommodating cavity is in communication with the reaction chamber; and the activated carbon trap is configured to separate noble gases in the reaction chamber.

9. An apparatus for measuring noble gas isotopes, comprising:
the gas purification device of claim 1; and
a noble gas isotope mass spectrometer;
wherein the noble gas isotope mass spectrometer is arranged on the gas purification device, and is configured to measuring noble gases in the gas purification device.

10. The apparatus of claim 9, wherein the purification mechanism comprises a water vapor removal assembly; the water vapor removal assembly is provided with a first accommodating cavity; the first accommodating cavity is communicated with the reaction chamber; and the water vapor removal assembly is configured to remove water vapor in the gas sample in the reaction chamber.

11. The apparatus of claim 10, wherein the water vapor removal assembly comprises a cold finger and a cooling agent; the first accommodating cavity is provided on the cold finger; and the cold finger is configured to be soaked in the cooling agent and to cool the water vapor in the reaction chamber to condense into ice.

12. The apparatus of claim 9, wherein the purification mechanism further comprises a reactive gas removal assembly; the reactive gas removal assembly is arranged on the housing; the reactive gas removal assembly is provided with a second accommodating cavity; the second accommodating cavity is in communication with the reaction chamber; and the reactive gas removal assembly is configured to remove reactive gases in the reaction chamber.

13. The apparatus of claim 12, wherein the reactive gas removal assembly is a reduction/distillation furnace for production of sponge titanium.

14. The apparatus of claim 9, wherein the purification mechanism further comprises a hydrogen gas removal assembly; the hydrogen gas removal assembly is arranged on the housing and is provided with a third accommodating cavity; the third accommodating cavity is in communication with the reaction chamber; and the hydrogen gas removal assembly is configured to remove hydrogen gas in the reaction chamber.

15. The apparatus of claim 14, wherein the hydrogen gas removal assembly is a zirconium-aluminum getter pump.

16. The apparatus of claim 9, wherein the purification mechanism further comprises an activated carbon trap; the activated carbon trap is arranged on the housing and is provided with a fourth accommodating cavity; the fourth accommodating cavity is in communication with the reaction chamber; and the activated carbon trap is configured to separate noble gases in the reaction chamber.

17. A method for measuring noble gas isotopes, comprising:
feeding a gas sample into a reaction chamber of the casing;
turning on a water vapor removal assembly to remove water vapor in the gas sample;
turning off the water vapor removal assembly, and turning on a reactive gas removal assembly to remove reactive gases in the gas sample treated by the water vapor removal assembly;
turning off the reactive gas removal assembly, and turning on a hydrogen gas removal assembly to remove hydrogen in the gas sample treated by the reactive gas removal assembly;
turning off the hydrogen gas removal assembly, and separating noble gases in the gas sample treated by the hydrogen gas removal assembly; and
turning on a noble gas isotope mass spectrometer to measure isotopes of individual noble gases.
